(19) United States
(12) Patent Application Publication
(10) Pub. No.: US 2003/0141359 A1
(43) Pub. Date: Jul. 31, 2003

(54) Method and apparatus for a voucher security system in gaming

(76) Inventors: Oleg Dymovsky, Los Angeles, CA (US); Eric Meyerhofer, Oceanside, CA (US)

Correspondence Address: CHRISTIE, PARKER & HALE, LLP, P.O. BOX 7068, PASADENA, CA, 91109-7068, US

(21) Appl. No.: 10/345,822

(22) Filed: Jan. 15, 2003

Related U.S. Application Data
(60) Provisional application No. 60/349,190, filed on Jan. 15, 2002.

(51) Int. Cl. G06F 17/00

(52) U.S. Cl. 235/375

(57) ABSTRACT

Method and apparatus for creating a voucher security system utilized in gaming which employs cashless enabled gaming systems, voucher printers with special reading and imaging capabilities, uniquely manufactured voucher media utilizing special inks and thermally sensitive coatings, and bill acceptors/voucher validators with special reading capabilities. The voucher security system ameliorates counterfeiting of vouchers by being able to detect invalid or counterfeit vouchers presented during redemption.

### CROSS-REFERENCE TO RELATED APPLICATION(S)

This application claims priority to provisional application No. 60/349,190 filed on Jan. 15, 2002, which is hereby incorporated by reference as if set forth in full herein.

### BACKGROUND OF THE INVENTION

This invention relates generally to pay-out vouchers used in cashless slot machines and gaming machines and more specifically to a system for gaming with counterfeit prevention features having printers printing and issuing the vouchers, electromechanical currency acceptors which redeem the vouchers, and a paper substrate upon which the vouchers are printed.

The gaming machine manufacturing industry provides a variety of gaming machines for the amusement of gaming machine players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers have more recently introduced cashless enabled games to the market and these have found a wide acceptance to date. cashless enabled games are so named due to the fact that they can conduct their financial exchange with a player with a mixture of traditional currency and vouchers. Typically, a cashless enabled game may have as an installed component a printer to produce the vouchers and a bill acceptor\voucher validator allowing automatic reading of a printed voucher. In a cashless enabled gaming system, when a player cashes out, the system is signaled and depending on the size of the pay out, the system can either present coins in the traditional method of a slot machine, or it can cause the printers which are installed in such machines to produce a voucher containing the value of the pay out. This voucher may then either be redeemed for cash with a cashier, or it may be inserted into a bill acceptor/voucher validator which is installed in the same or another cashless enabled slot machine at a participating casino, at which point the system will recognize the voucher, redeem it, and place the appropriate amount of playing credits on the game.

Cashless enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. Since these games essentially print pay-out vouchers which are equivalent to “cash”, wide spread use of cashless enabled games in casinos has brought revelations as to the methodologies of which certain individuals will use to attempt to cheat the system. It has become apparent that casino operators desire to install cashless enabled games due to their business advantages, but harbor concerns about the security of the system and the prevention or at least minimization of counterfeiting. To date, known actual or possible counterfeiting measures include photocopying a real voucher and redeeming the photocopy through the bill acceptor\voucher validator while attempting to redeem the real voucher with a cashier and casino employees printing a log of issued but as yet unredeemed vouchers while in possession of a printer and blank casino voucher stock, then printing off their own copies of these same vouchers, and redeeming the vouchers with a cashier or through the system.

### SUMMARY OF THE INVENTION

A method and apparatus for creating a voucher security system utilized in gaming which employs cashless enabled gaming systems, voucher printers with special reading and imaging capabilities, uniquely manufactured voucher media utilizing special inks and thermally sensitive coatings, and bill acceptors/voucher validators with special reading capabilities is provided. The voucher security system ameliorates counterfeiting of vouchers by being able to detect invalid or counterfeit vouchers presented during redemption.

In one aspect of the present invention, a three way voucher security system has functions operating within the security system which are performed properly in order for a voucher to be redeemed. These functions are performed by specialized equipment not readily available. A first entity in the system is a voucher printer in a cashless enabled game as a sourcing entity where the voucher is created using a specialized heating and printing algorithm. A second entity is voucher media upon which the vouchers are printed which provides the transport of monies from the machine, being specially prepared and difficult to counterfeit. A third entity is a bill acceptor/voucher validator installed in a cashless enabled game, at a game table, or within a cashiers cage, or a human cashier, as a receiving entity that senses special symbols, marks, colors, or optical responses to ensure that voucher was printed on certified voucher media and prepared with a special heating printing algorithm as defined by the system.

In another aspect of the invention, the voucher media upon which the vouchers are printed is impregnated or over coated with a thermally activated ink which produces a color, barcode, symbol or word when a specific amount of heat is applied to that section of the voucher media to perform visual signaling to a cashier, or optical signaling to a bill acceptor/voucher validator of validity. The specific amount of heat required to produce the image would be at a different threshold than the surrounding printable area, so that an ordinary thermal printer not performing the special heating algorithm would smear, discolor, or in some other way degrade the proper image and thus would be unable to produce a proper visual or optical signature on the voucher. In this manner, only a thermal printer performing a specialized heating and printing algorithm would be able to produce a redeemable voucher.

In another aspect of the invention, the thermal printer including the special printing and heating algorithm described in the prior paragraph fails to operate outside of a real-time communications environment which would be found in a variety of gaming machines, thus resulting in a specialized voucher printer which is only enabled to operate when it believes it is operating inside an actual gaming machine.

In another aspect of the invention, the voucher media upon which the vouchers are printed includes a mark, whether it be a character or characters, a pattern or patterns, a symbol or symbols, or a barcode or barcodes (hereinafter referred to as “mark” or in the case of a plurality as “marks”) , which would be printed in two or more inks whose opacity are similar in the human visible spectrum, but whose opacity differ in other spectrums used by standard photocopiers or scanners, such that only the portion of the Mark or Marks created in a subset of the inks would reproduce on such equipment, and additionally inks whose opacity would all be recognizable by bill acceptors/voucher validataors used in the gaming industry. The function of this aspect of the invention is that a voucher which had been photocopied, or scanned and printed, on readily available reproduction equipment would not bear a complete visual and optical signature in the mark or marks, preventing redemption at either at the cashier's cage or through a bill acceptor/voucher validator in a cashless game or at a game table.

In another aspect of the invention, the bill acceptor/voucher validator in a cashless game, at a game table, or in a cashiers cage scans the particular area of the ticket where the mark or marks would appear to verify that the optical signatures of all portions of the mark(s) were correct in signature and position, thereby preventing redemption of a voucher which is a photocopy style reproduction.

In another aspect of the invention, the bill acceptor/voucher validator in a cashless game, at the game table, or in a cashiers cage scans the thermally sensitive side of the voucher in the region where the special heating algorithm is applied by the printer, for a proper pattern or optical signature which would be encoded there, thereby preventing redemption of a voucher which had been prepared on a standard thermal printer.

In another aspect of the invention, the voucher printer in the system scans for a preprinted mark or marks on the blank voucher media before or during printing of the voucher to confirm that the voucher is being imaged on a voucher media which is compliant with the system, and if improper voucher media was so detected, then the voucher printer would either void the ticket in print or halt function until proper voucher media was loaded.

In another aspect of the invention, the preprinted mark or marks are used to signal both the printer and the bill acceptor/voucher validator where to physically print and scan respectively on the side of the voucher imaged at the time of cash out for the pattern which was prepared by the special heating algorithm in the voucher printer, thereby creating a more sophisticated barrier to cloning a printing algorithm for counterfeiting vouchers.

In another aspect of the invention, the preprinted mark or marks are used to signal the printer as to how to apply a specialized heat algorithm to match a variation in the selective coating process on the blank voucher media described earlier, and to indicate to the bill acceptor/voucher validator what the optical characteristics of the pattern so created are, thereby creating a more sophisticated barrier to cloning a printing or bill acceptor algorithm for counterfeiting vouchers.

In another aspect of the invention, a validation number, or portions thereof, which is provided by the gaming cash out system and printed on the vouchers, would be used in a hash algorithm to instruct the voucher printer on algorithm adjustment aspects of imaging the thermally sensitive side of the voucher, and the same validation number portion being used to instruct the bill acceptor to scan for the same aspects which were produced by the printer.

### BRIEF DESCRIPTION OF THE DRAWINGS

These and other features, aspects, and advantages of the present invention will become better understood with regard to the following description, appended claims, and accompanying drawings where:

FIG. 1 is a diagram of the triangular voucher security system approach in accordance with the present invention;

FIG. 2 is an illustration of an exemplary voucher currently used in gaming;

FIG. 3 is an illustration of an exemplary voucher with a thermally sensitive side (the side printed by the printer in the game at the time of cash out) and having a special inking or coating zone in accordance with the present invention;

FIG. 4A is an illustration of an exemplary voucher back side (the voucher media-factory pre-printed field) with a typical symbol exhibiting different optical characteristics in accordance with the present invention;

FIG. 4B is an illustration of an exemplary voucher with preprinted sections on both the thermally sensitive side (the side printed by the printer in the game at the time of cash out) and the back side (the voucher media-factory pre-printed field) with a typical symbol exhibiting different optical characteristics in accordance with the present invention;

FIG. 5 is an illustration of an exemplary voucher with a thermally sensitive side (the side printed by the printer in the game at the time of cash out) and an image shape and position that is printed based upon the content of the validation number (either human readable or bar code) in accordance with the present invention; and

FIG. 6 is a block diagram of a controller used in a voucher printer in accordance with an exemplary embodiment of the present invention.

### DETAILED DESCRIPTION OF THE INVENTION

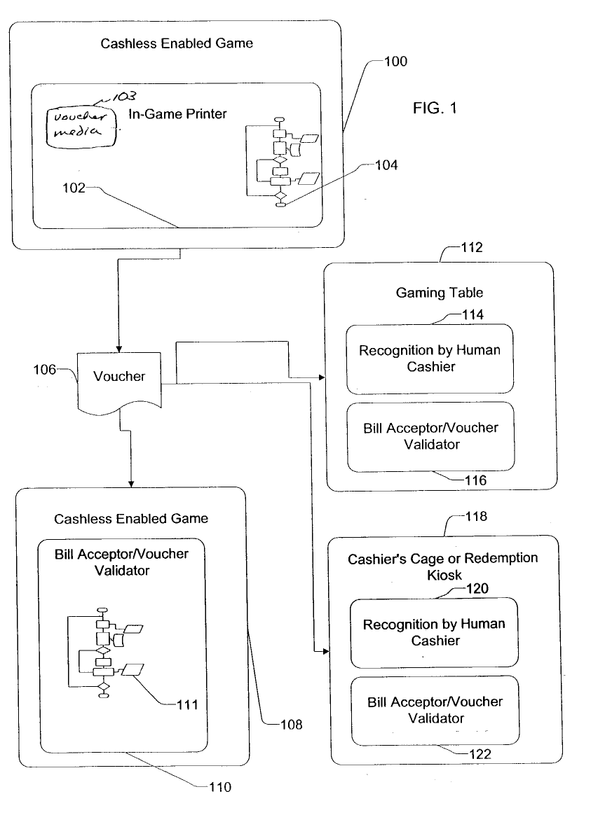

FIG. 1 is an illustration of the triangular voucher security system approach in accordance with the present invention. A cashless enabled game 100 includes a voucher printer 102, customized voucher media 103, and heating and printing algorithms 104. The cashless enabled game activates the voucher printer to issue a voucher 106. The voucher printer generates the voucher using the heating and printing algorithms in conjunction with the characteristics of the customized voucher media. The voucher includes cash-out information as well as activated security features. Redemption of the voucher at a gaming table 112, a cashier's cage or redemption kiosk 118, or another cashless enabled game 108 is only accepted after the voucher passes verification of the security signatures and features using one of bill acceptor\voucher validators 116, 122, and 110 respectively. Each of the bill acceptor\voucher validators includes validation algorithms for determining if the voucher is valid, as exemplified by validation algorithms 110.

As illustrated above, a three way voucher security system defines a set of functions operating within the security system that are performed properly in order for a voucher to be redeemed. These functions are performed by specialized equipment not available to an average person. The first entity in the system the voucher printer in a cashless enabled game as the sourcing entity where a voucher is generated using a heating and printing algorithm. The second entity is the blank appearing voucher media upon which the voucher is printed which provides the transport of monies from the machine. The voucher media is specially prepared and difficult to counterfeit as it has anticounterfeiting features. The third entity is the bill acceptor\voucher validator installed in a cashless enabled game, at a game table, or within the cashiers cage as a receiving entity validating special symbols, marks, colors, or optical responses to ensure that a voucher was printed on certified voucher media and prepared with a special printing algorithm as specified by the system. As many of the special symbols, marks, colors, or optical responses are human discernable or readable, a human cashier may also act as a receiving entity as indicated by cashiers 114 and 120.

As an added security precaution, the voucher printer including the heating and printing algorithms operates only within the context of a real-time communications environment which is found in a variety of gaming machines. Thus the voucher printer is only enabled to operate when it senses it is operating inside an actual gaming machine.

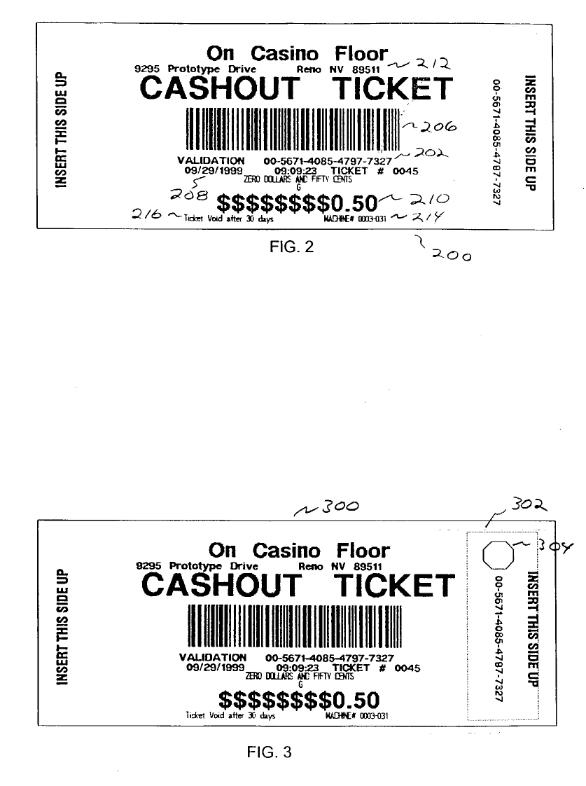

FIG. 2 is an illustration of an exemplary voucher currently used in gaming. A voucher 200 is produced from commands issued by the cashless enabled game in response to a player's request to cash-out. The voucher includes features such as a validation number 202, printed in both a human readable form and in a machine-readable form as a bar code 206, time and date stamps 208, cash out amount 210, casino location information 212, cashless enabled game ID 214, and an expiration date 216. The information contained on the voucher is sufficient to verify that a valid cash-out request was generated at some time, but may not ensure that the voucher presented for redemption is an original and not a duplicate or forgery.

FIG. 3 is an illustration of an exemplary voucher with a thermally sensitive side (the side printed by the voucher printer in a cashless game at the time of cash-out) and having a special inking or coating zone in accordance with an exemplary embodiment of the present invention. A voucher 300 includes information included in the voucher 200 of FIG. 2, however, the voucher also includes a security feature area 302. The use of a proprietary heating and printing algorithm 104 within a voucher printer 102 takes into account information provided by both a cashless enabled game 100 and the special voucher media 103 (all of FIG. 1) to create a security image 304 within the zone shown. Verification of the finished voucher is accomplished by use of a specially outfitted bill acceptor/voucher validator.

The blank voucher media upon which vouchers are printed is impregnated or over coated with a thermally activated ink which produces a color, bar code, symbols, or word when a specific amount of heat is applied to an appropriate section of the voucher. This provides visual signaling to a cashier, or optical signaling to a bill acceptor\voucher validator, of validity. The specific amount of heat required to produce the image is at a different threshold than the surrounding printable area, so that an ordinary thermal printer not performing a special heating algorithm would smear, discolor, or in some other way degrade the proper image and thus would be unable to produce a proper visual or optical signature on the voucher. In this manner, only a thermal printer performing a specialized heating and printing algorithm would be able to produce a redeemable voucher.

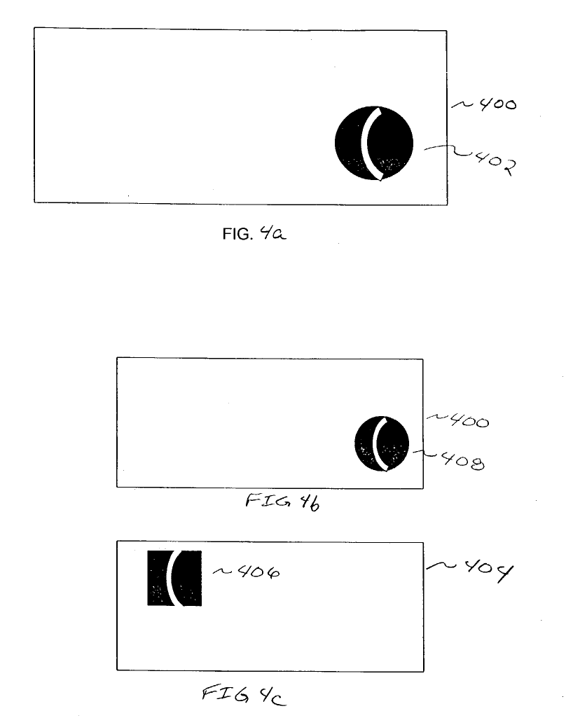

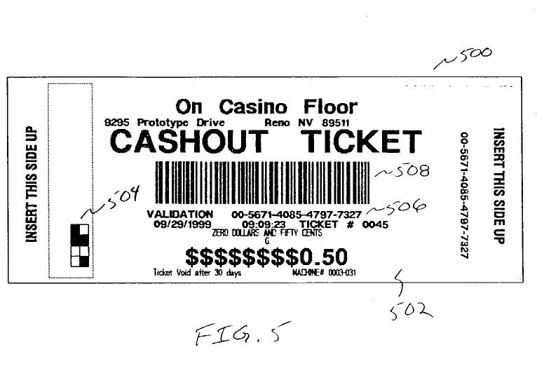

FIG. 4A is an illustration of an exemplary voucher media back side 400 (the voucher media-factory pre-printed field) with a typical symbol 402 exhibiting different optical characteristics in accordance with the present invention. Printing on such a specially manufactured voucher media, that utilizes special inks each exhibiting different optical properties, allows the media to be validated as original and also provides both the voucher printer and the bill acceptor/voucher validator with additional information that can be used in generation and validation of the thermally sensitive side (side printed at cash out).

FIG. 4B and FIG. 4c are illustrations of an exemplary voucher media with preprinted sections on both the thermally sensitive side 404 (the side printed by the printer in the game at the time of cash out) and a back side (the voucher mediafactory pre-printed field) 400 with typical symbols, 406 and 408, exhibiting different optical characteristics in accordance with the present invention. Printing on such a specially manufactured voucher media, that utilizes special inks each exhibiting different optical properties, allows the media upon which a voucher is printed to be validated as original and also provides both the voucher printer and the bill acceptor/voucher validator with additional information that can be used in generation and validation of a thermally sensitive side which is the side printed at cash out. Double- sided pre-printing provides a further barrier to counterfeiting.

In another voucher media in accordance with an exemplary embodiment of the present invention, the blank voucher media upon which the vouchers are printed includes a mark, such as a character or characters, a pattern or patterns, a symbol or symbols, or a bar code or bar codes (hereinafter referred to as “mark” or in the case of a plurality as “marks”), which is printed in two or more inks whose opacity are similar in the human visible spectrum, but whose opacity differs in different spectrums used by standard photocopiers or scanners, such that only the portion of the mark or marks created in a subset of the inks would reproduce on such equipment. In addition, the inks have an opacity that is recognizable by bill acceptors used in the gaming industry. The function of the mark is that a voucher that has been photocopied, or scanned and printed, on readily available reproduction equipment would not bear a complete visual and optical signature in the mark or marks, thus preventing redemption of the voucher at either the cashier's cage or through a bill acceptor/voucher validator in a game or at a game table.

As another security precaution, the bill acceptor/voucher validator in a cashless enabled game, at a game table, or in a cashier's cage scans the particular area of the ticket where the mark or marks appears. This verifies that the optical signatures of all portions of the mark(s) are correct in signature and position, thereby preventing redemption of a voucher which is a photocopy style reproduction.

A bill acceptor/voucher validator in the cashless enabled game, at the game table, or in the cashier's cage also scans the thermally sensitive side of the voucher in the region where the special heating algorithm is applied by the printer. If the voucher media is valid, there will be a proper pattern or optical signature which is encoded there, thereby preventing redemption of a voucher which is prepared on a standard thermal printer.

The mark or marks are also used by a voucher printer to verify that the voucher media used by the voucher printer is valid. The voucher printer in the system scans for the preprinted mark or marks on the blank voucher stock before or during printing of the voucher to confirm that the voucher is being imaged on a voucher stock which is compliant with the system. If improper voucher stock was so detected, then the printer either voids the ticket in print or halts functioning until proper voucher media is loaded.

The preprinted mark or marks may be used to signal both the voucher printer and the bill acceptor/voucher validator where to physically print and scan respectively on the side of the voucher imaged at the time of cash-out for the pattern which was prepared by the special heating algorithm in the printer, thereby creating a more sophisticated barrier to cloning a printing algorithm for counterfeiting vouchers.

In another mark in accordance with an exemplary embodiment of the present invention, the preprinted mark or marks are used to signal the printer as to how to apply a specialized heat algorithm to match a variation in the selective coating process on the blank voucher stock described earlier, and to indicate to the bill acceptor/voucher validator what the optical characteristics of the pattern so created are, thereby creating a more sophisticated barrier to cloning a printing or bill acceptor/voucher validator algorithm for counterfeiting vouchers.

FIG. 5 is an illustration of an exemplary voucher 500 with a thermally sensitive side (the side printed by the printer in the game at the time of cash out) 502 and an image shape 504 whose configuration and position is based upon the content of a validation number (either human readable 506 or bar code 508) in accordance with the present invention. The validation number is a number generated by the cashless enabled game and is used to track the validity of the cash out transaction. Taking this number and generating a unique security key can be done by various means including hashing, Hamming, or other algorithms. This unique key can then be used to specify to the voucher printer a specific shape and location for that shape to be printed on the voucher. In addition, a bill acceptor/voucher validator, can also read the validation number (either through the bar code or recognition of the validation number) and verify the shape printed on the voucher matches that predicted by unique key generated from the validation number as mentioned.

In another voucher printer, the validation number, or portions thereof, which is provided by the gaming cash out system and printed on the vouchers, would be used in a hash algorithm to instruct the printer on algorithm adjustment aspects of imaging the thermally sensitive side of the voucher, and the same validation number portion being used to instruct the bill acceptor/voucher validator to scan for the same aspects which were produced by the printer.

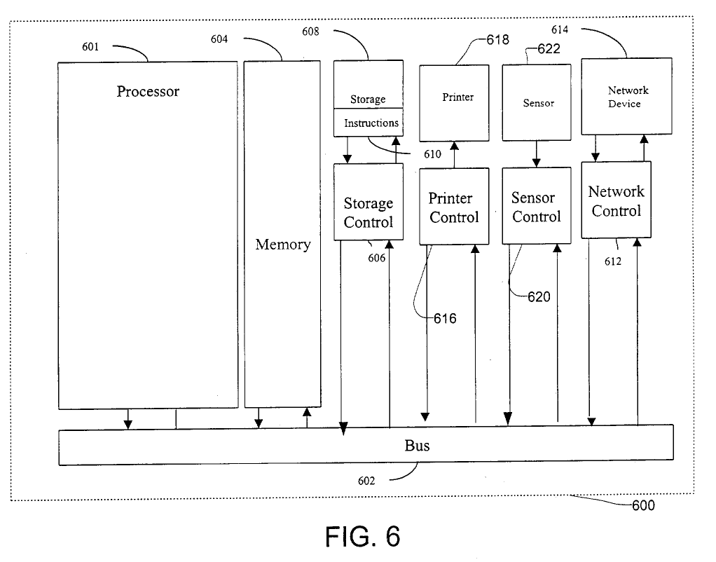

FIG. 6 is a block diagram of a voucher printer controller used in a voucher printer in accordance with an exemplary embodiment of the present invention. A voucher printer controller 600 includes a processor 601, operatively coupled via a system bus 602 to a memory 604. The processor is further operatively coupled via the system bus to a storage controller 606. The storage controller is operatively coupled to storage device 608. Program instructions 610 implementing previously described heating and printing algorithms are stored in the storage device until the processor retrieves the program instructions and stores them in the memory. The microprocessor then executes the program instructions stored in the memory to implement the features of the voucher printer as previously described.

The processor is further coupled via the system bus to a network controller 612 which is coupled to a networking device 614. The voucher printer controller uses the networking device to transmit and receive control signals from a gaming system as previously described.

The processor is further coupled via the system bus to a printer controller 616 which is coupled to a printer mechanism 618. The voucher printer controller uses the printer mechanism to generate vouchers as previously described.

The processor is further coupled to an input controller 620 which is coupled to a sensor device. The voucher printer controller uses the user input device to receive sensor inputs generated by reading anticounterfeiting from voucher media as previously described.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A voucher generation and redemption system for gaming, comprising:
a voucher printer;
voucher media having anticounterfeiting features, the voucher media usable by the voucher printer to generate vouchers; and
a voucher validator to redeem the voucher upon detection of the anticounterfeiting features.
